(19) United States
(12) Patent Application Publication
(10) Pub. No.: US 2018/0267748 A1
(43) Pub. Date: Sep. 20, 2018

(54) PRINTING CONTROL APPARATUS, PRINTING APPARATUS, AND PRINTING CONTROL METHOD

(71) Applicant: SEIKO EPSON CORPORATION, Tokyo (JP)

(72) Inventors: Minoru Takizawa, Shiojiri-shi (JP); Hiroyuki Tsuji, Matsumoto-shi (JP)

(73) Assignee: SEIKO EPSON CORPORATION, Tokyo (JP)

(21) Appl. No.: 15/921,287

(22) Filed: Mar. 14, 2018

(30) Foreign Application Priority Data
Mar. 17, 2017 (JP) 2017-052344

(51) Int. Cl. G06F 3/12; H04N 1/00

(52) U.S. Cl. CPC G06F 3/1207; H04N 1/00909; G06F 3/1259; G06F 3/1294; H04N 1/00053

(57) ABSTRACT

A printing control apparatus including an inspection result acquisition unit that acquires an inspection result of an ejection state in each of a plurality of nozzles in an ejection head having the nozzles, and an evaluation result acquisition unit that acquires evaluation result information from an evaluation result acquired by evaluating a print image printed in an accumulated ejection state of the nozzle, in which before performing a print job, based on the inspection result and the evaluation result information, a print state relating to the print job is predicted and the predicted result is displayed.

### BACKGROUND

### 1. Technical Field

The present invention relates to a printing control apparatus, a printing apparatus, and a printing control method.

### 2. Related Art

In a related art, known is an ejection inspection apparatus in which an image quality value is calculated based on an inspection result acquired by inspecting an ejection state of a nozzle of an ejection head, and the ejection head is controlled to perform an allowable ejection process without performing cleaning when the calculated image quality value is within an allowable range, and on the other hand, a cleaning unit is controlled to perform the cleaning when the image quality value exceeds the allowable range (for example, see JP-A-2010-179577).

However, since a condition in which printing in the ejection inspection apparatus is allowed and a condition in which performance of the cleaning is allowed vary based on contents of a printed matter and a user, if a cleaning process is performed regardless of, for example, the intention of the user, the productivity of the print process decreases. In addition, there is a problem that the convenience of the user is lacked.

### SUMMARY

The invention can be realized in the following aspects or application examples.

### Application Example 1

According to this application example, there is provided a printing control apparatus including: an inspection result acquisition unit that acquires an inspection result of an ejection state in each of a plurality of nozzles in an ejection head having the nozzles; and an evaluation result acquisition unit that acquires evaluation result information from an evaluation result acquired by evaluating a print image printed in an accumulated ejection state of the nozzle, in which before performing a print job, based on the inspection result and the evaluation result information, a print state relating to the print job is predicted and the predicted result is displayed.

According to the configuration, before performing a print process, based on the inspection result of the ejection state of the nozzle and the evaluation result information of the print image in the past, the image quality of the print job to be printed is predicted and the predicted result is displayed. Therefore, for example, by checking the predicted result by the user, even in a case where nozzle slipping-out or the like occurs, the print process can be performed without performing cleaning in the print job. Therefore, it is possible to improve the productivity of the print process and user's convenience.

### Application Example 2

In the printing control apparatus according to the application example, a plurality of the print jobs are displayed, and an order of performing the print jobs can be changed.

According to the configuration, the user can check statuses of the plurality of print jobs at a glance. Then, according to a result of an inspection unit, that is, according to the ejection state of the nozzle, it is possible to exchange the print jobs. In addition, it is possible to measure a timing of the maintenance of the ejection head of the cleaning or the like based on status of the print job and to improve the user's convenience.

### Application Example 3

According to the application example, the printing control apparatus further includes a specification unit that specifies a feature area of the print image in the print job, in which before performing the print job, a part of the specified feature area is printed.

According to the configuration, for example, an image area (for example, gray color, flesh color, red color, and solid pattern) in which streak unevenness of the like of an image easily occurs is specified and the specified area is printed. With this, it is possible for the user to easily check image quality in advance, and it is possible to reduce the number of steps by the occurrence of printing failure and reprinting.

### Application Example 4

In the printing control apparatus according to the application example, after the print job is completed, the evaluation result information that is input is accumulated in an evaluation result information accumulation unit.

According to the configuration, it is possible to input the evaluation result of an image printed actually in the ejection state (for example, in a state where there is nozzle slipping-out) of a certain nozzle. By accumulating the input evaluation result in the evaluation result information accumulation unit, it is possible to use the accumulated result in the prediction of the print state at the time of performing the next print job.

### Application Example 5

According to the application example, information relating to a user is included in the evaluation result information of the printing control apparatus.

According to the configuration, it is possible to acquire information for each user and to perform prediction or the like of the print state based on the evaluation for each user.

### Application Example 6

According to the application example, in the printing control apparatus, the predicted result of each print job is displayed, a control operation corresponding to each of the predicted results is displayed, and the control operation is reserved.

According to the configuration, the predicted result of each print job is displayed and the control operation that can be handled by each print job is displayed. Then, in each print job, for example, since the control operation such as the cleaning of the ejection head can be reserved and the user does not need to wait for each print job and set the control operation, it is possible to improve the user's convenience.

### Application Example 7

According to the application example, in the printing control apparatus, the control operation already reserved can be canceled.

According to the configuration, even in a case where a control operation is reserved in advance, for example, when an abnormality such as the nozzle slipping-out is recovered, since it is unnecessary to perform the cleaning or the like, by canceling the reservation, it is possible to suppress the wasteful use of the ink and to improve the productivity.

### Application Example 8

According to the application example, in the printing control apparatus, a condition of canceling the control operation already reserved can be set.

According to the configuration, since it is possible to set a cancel condition, it is possible to improve the convenience.

### Application Example 9

According to the application example, in the printing control apparatus, while performing the print job, based on the inspection result and the evaluation result information of other print jobs, the print state relating to other print jobs is predicted and the predicted result is displayed.

According to the configuration, even while a certain print job is being performed, since the determination of printing performance of the next print job is performed, it is possible to improve the user's convenience.

### Application Example 10

According to this application example, there is provided a printing control method of a printing control apparatus that inspects an ejection state in each of a plurality of nozzles in an ejection head having the nozzles, and acquires evaluation result information from an evaluation result acquired by evaluating a print image printed in an accumulated ejection state of the nozzle. The method includes before performing a print job, predicting a print state relating to the print job based on the inspection result and the evaluation result information, and displaying the predicted result.

According to the configuration, before performing a print process, based on the inspection result of the ejection state of the nozzle and the evaluation result information of the print image in the past, the image quality of the print job to be printed is predicted and the predicted result is displayed. Therefore, for example, by checking the predicted result by the user, even in a case where nozzle slipping-out or the like occurs, the print process can be performed without performing the cleaning in the print job. Therefore, it is possible to improve the productivity of the print process and to improve user's convenience.

### Application Example 11

A printing apparatus according to this application example includes the printing control apparatus.

According to the configuration, before performing a print process, based on the inspection result of the ejection state of the nozzle and the evaluation result information of the print image in the past, the image quality of the print job to be printed is predicted and the predicted result is displayed. Therefore, for example, by checking the predicted result by the user, even in a case where nozzle slipping-out or the like occurs, the print process can be performed without performing the cleaning in the print job. Therefore, it is possible to provide a printing apparatus that improves the productivity of the print process and user's convenience.

### BRIEF DESCRIPTION OF THE DRAWINGS

The invention will be described with reference to the accompanying drawings, wherein like numbers reference like elements.

FIG. 1 is a schematic diagram showing a configuration of a printing apparatus according to a first embodiment.

FIG. 2 is a flowchart showing a printing control method according to the first embodiment.

FIG. 3 is an explanatory diagram for explaining an example of a display method in a display unit according to the first embodiment.

FIG. 4 is an explanatory diagram for explaining another example of the display method in the display unit according to the first embodiment.

FIG. 5 is an explanatory diagram for explaining still another example of the display method in the display unit according to the first embodiment.

FIG. 6 is an explanatory diagram for explaining still another example of the display method in the display unit according to the first embodiment.

FIG. 7 is an explanatory diagram for explaining still another example of the display method in the display unit according to the first embodiment.

FIG. 8 is an explanatory diagram for explaining still another example of the display method in the display unit according to the first embodiment.

FIG. 9 is a flowchart showing a printing control method according to a second embodiment.

FIG. 10 is an explanatory diagram for explaining an example of a display method in a display unit according to the second embodiment.

FIG. 11 is an explanatory diagram for explaining another example of the display method in the display unit according to the second embodiment.

FIG. 12 is an explanatory diagram for explaining still another example of the display method in the display unit according to the second embodiment.

FIG. 13 is an explanatory diagram for explaining a part of the display method in the display unit according to the second embodiment.

FIG. 14 is an explanatory diagram for explaining an example of a display method in a display unit according to Modification Example 1.

FIG. 15 is an explanatory diagram for explaining another example of the display method in the display unit according to Modification Example 1.

### DESCRIPTION OF EXEMPLARY EMBODIMENTS

Hereinafter, embodiments of the invention will be described with reference to the drawings. In each of the following drawings, the scale of each member or the like is shown different from the actual scale in order to make each member and the like to be recognizable.

### First Embodiment

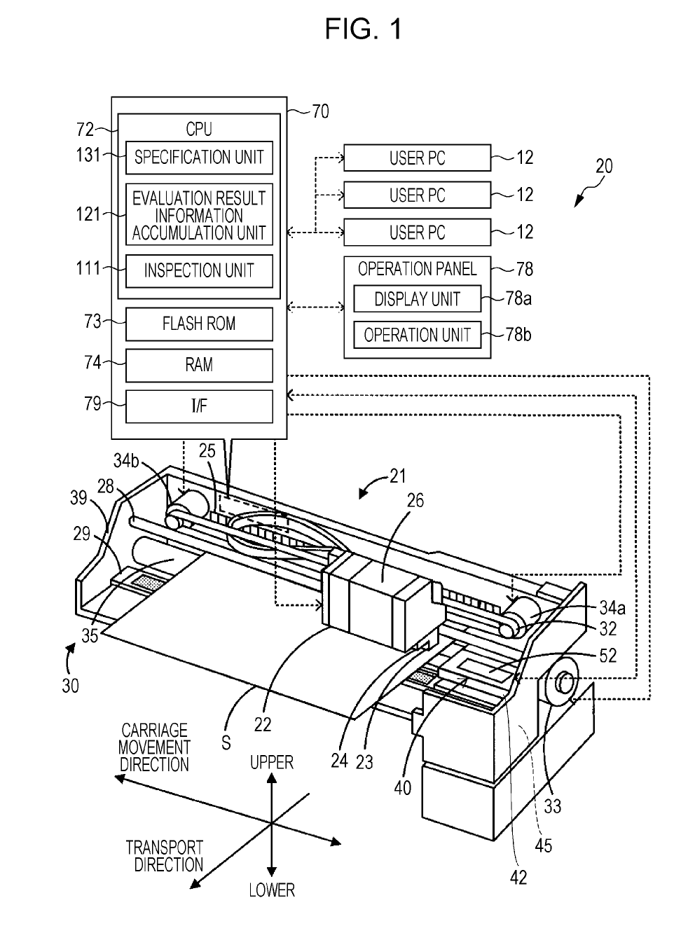

First, a configuration of a printing apparatus will be described. FIG. 1 is a schematic configuration showing a configuration of the printing apparatus. As described in FIG. 1, a printing apparatus 20 is an ink jet printer, and includes a printing mechanism 21 including an ejection head 24 that ejects ink as a fluid on a recording sheet S, a sheet feed mechanism 30 that transports the recording sheet S, a capping device 40 that performs sealing and cleaning of the ejection head 24, an operation panel 78 that displays a screen of information and accepts input from a user, and a printing control apparatus 70 that controls the entirety of the printing apparatus 20. At this time, the printing control apparatus 70 may be configured to control the printing apparatus 20 by being installed with a PC other than the printing apparatus, and may be a RIP device to generate and transfer print data to the printing apparatus 20 by being installed with the PC other than the printing apparatus.

The printing mechanism 21 includes a carriage 22 that reciprocates in a left-right direction (main scanning direction) by a carriage belt 32 along a carriage shaft 28, the ejection head 24 that ejects ink droplet as a fluid from nozzles 23 corresponding to each color ink, and an ink cartridge 26 that accommodates each color ink and supplies the accommodated ink to the ejection head 24. The carriage 22 is moved as the carriage belt 32 bridged between a carriage motor 34a attached to one side of a housing 39 and a driven roller 34b attached to the other side of the housing 39, is driven by the carriage motor 34a. A linear encoder 25 for detecting a position of the carriage 22 is installed on a rear surface of the carriage 22, a position of the carriage 22 can be managed by using the linear encoder 25. The ejection head 24 includes a plurality of nozzles 23. The ejection head 24 is installed on a lower portion of the carriage 22. Then, an ink is pressed by applying a voltage to a piezoelectric element corresponding to each of the nozzles 23 and by deforming the piezoelectric element such that it is possible to eject each color ink from each of the nozzles 23. The ink cartridge 26 is mounted on the carriage 22, and separately accommodates inks of respective colors used for printing such as cyan (C), magenta (M), yellow (Y), and black (K), which include pigments and dyes as colorants in water as a solvent.

The sheet feed mechanism 30 includes a sheet feed roller 35 which is driven by a driving motor 33, and transports the recording sheet S on a platen 29 from the back to the front in the drawing, a sheet roller for feeding the recording sheet S mounted on a tray (not shown) to the platen 29, a sheet ejection roller for transporting the recording sheet S on which the ink is ejected in the platen 29 to a sheet ejection tray (not shown), and the like.

The capping device 40 includes a capping member 42 as a housing formed as an insulating member having an approximately rectangular parallelepiped shape and an upper portion thereof opened is used, and is installed at an initial position (home position) of the carriage 22. A concave shape flushing area 52 is formed on the capping member 42. The flushing area 52 is used when a flushing operation of causing ejection of the ink from the nozzle 23 of the ejection head 24 is performed. In addition, the capping device 40 is supported to move in a vertical direction by an elevating mechanism (not shown), used for a cleaning process for sucking out the ink clogged in the nozzle 23, and also used for sealing the nozzle 23 in order to prevent the nozzle 23 from drying out during printing pause or the like. To the capping device 40, a suction pump is connected through a suction tube, an opening and closing valve through a suction tube is connected, and a negative pressure generation unit 45 for generating negative pressure to an internal space of the capping device 40 by driving the suction pump when the opening and closing valve is in a closed state is connected, and it is possible to perform the cleaning for forcibly sucking out the ink in the nozzle 23 by generating the negative pressure when the capping device 40 seals the nozzle 23.

The operation panel 78 is a device for inputting various instructions to the printing apparatus 20 by users, includes a display unit 78a configured with a color liquid crystal panel on which characters and images are displayed according to the various instructions, and an operation unit 78b in which up, down, left, and right keys for performing various operations, a decision key, a cancel key, and the like are provided, and can be operated with a mouse and a keyboard.

The printing control apparatus 70 is configured with a microprocessor including a CPU 72, a flash ROM 73 capable of storing various processing programs and rewriting data, a RAM 74 for temporarily storing and saving the data, and an interface (I/F) 79 for performing exchange of data with an external device such as a plurality of user's personal computers (user PC) 12. Each processing program including an inspection routine for an ejection state of the nozzle 23 (which will be described below), a cleaning process routine, print process routine, and the like is stored in the flash ROM 73. A printing buffer area is provided in the RAM 74, and the print job or the like sent from an external device such as the user's personal computer (user PC) 12 through the I/F 79 is stored therein.

In addition, the CPU 72 includes an inspection unit 111, an evaluation result information accumulation unit 121, a specification unit 131, and the like.

The inspection unit 111 inspects the ejection state of each nozzle 23 in the ejection head 24 including the plurality of nozzles 23. The inspection unit 111 includes a residual vibration detection circuit, and determines whether or not the ink droplet is appropriately ejected from each nozzle 23 of the ejection head 24 according to a nozzle state detection instruction, that is, detects whether or not the ink droplet of an arbitrary dot size of the arbitrary number of times can be ejected at an arbitrary timing for each nozzle 23. Then, the CPU 72 determines that the nozzle 23 which can appropriately eject the ink droplet is a normal nozzle based on an inspection result. Meanwhile, it is determined that the nozzle 23 which cannot appropriately eject the ink droplet is a defective nozzle.

The inspection method of the inspection unit 111 vibrates the piezoelectric element corresponding to each nozzle 23, and displaces a diaphragm corresponding to each nozzle. When an operation of ejecting the ink droplet is performed by increasing or decreasing the pressure of a cavity by the displacement of the diaphragm, the residual vibration of the diaphragm displaced by driving of the piezoelectric element is detected and whether the ink droplet is appropriately ejected or not ejected is detected based on a vibration pattern the detected residual vibration.

The evaluation result information accumulation unit 121 stores evaluation result information acquired by evaluating a print image printed in the ejection state of an arbitrary nozzle 23. Specifically, the ejection state of the nozzle 23 is acquired by driving the inspection unit 111 for each print job, an evaluation result on the print image formed on the recording sheet S is stored when the print job is performed in the acquired ejection state. The evaluation of the print image formed on the recording sheet S is performed by the user, and the evaluation result is stored in the evaluation result information accumulation unit 121 by inputting an operation on the operation panel 78 (corresponding to input unit). The evaluation result information stored in the evaluation result information accumulation unit 121 is data acquired by correlating the print image to be printed in the print job and the ejection state of the nozzle 23.

In addition, the evaluation result information stored in the evaluation result information accumulation unit 121 includes information acquired by correlating the data acquired by correlating the print image to be printed in the print job and the ejection state of the nozzle 23 for each user. With this, by collecting information for image quality of the printed image for each user, it is possible to accumulate the data correlating the ejection state of the nozzle 23 and the evaluation result for each user. The evaluation result information may be stored in the printing apparatus 20, or may be stored in a storage area on a PC as a terminal device other than the printing apparatus 20, the storage area of the RIP device, and the storage area of a server.

In addition, the CPU 72 can acquire the acquisition of the inspection result by the inspection unit 111 and the evaluation result information from the evaluation result information accumulation unit 121, and has functions as an inspection result acquisition unit and an evaluation result acquisition unit.

The CPU 72 predicts the print state relating to the print job, and displays the predicted result on the display unit 78a based on the inspection result of the inspection unit 111 and the evaluation result information stored in the evaluation result information accumulation unit 121 before performing the print job. As the predicted result, for example, when it is predicted that the quality of the print image is secured, “printing is OK” is displayed, and when it is predicted that the quality of the print image is not secured, “printing is NG” is displayed.

In addition, the CPU 72 causes the display unit 78a to display a control operation which can correspond to each predicted result in addition to the predicted result. The control operation is a maintenance operation (for example, flushing, cleaning, test pattern printing, or the like) of each ejection head 24. Furthermore, before performing each print job, it is possible to reserve the performance of each control operation.

In addition, it is possible to display a list of a plurality of print jobs on the display unit 78a. That is, it is possible to display the plurality of print jobs transmitted from the same user PC 12 and the print job transmitted from a plurality of the user PCs 12. In addition, it is also possible to display the predicted result in each print job. Furthermore, an order of the performance of the print job can be changed. Therefore, it is possible to perform a print process with priority assigned to the plurality of print jobs according to the inspection result of the inspection unit 111.

The specification unit 131 specifies a feature area of the print image in the print job. Specifically, for example, in a case where there is the feature area which can have a relatively large influence on the image quality, such as an area where streak unevenness is likely to occur in the print image in the print job, it is possible to specify the area. An image size (for example, 100 mm×100 mm or more) and color (for example, flesh color, gray color, and the like) to be the feature area can be arbitrarily combined and set in advance. For example, as the setting of the image size to be the feature area, a plurality of sizes (for example, 100 mm×100 mm or more, 60 mm×60 mm or more and 100 mm×100 mm or less, 60 mm×60 mm or less, and the like) can be set. In addition, the setting of color to be the feature area is not limited to a case where colors are perfectly matched, for example, each ink color (cyan, magenta, yellow, black, and the like) of the feature area but may be set to be the same color according to the degree (when each gradation value of cyan, magenta, yellow, black, or the like in feature area is converted to histogram, there is 50% or more of area where difference in histogram value at certain gradation value is within ±10 or the like) of each gradation of each ink color of the feature area.

Then, the CPU 72 can cause a part of the feature area designated in the specification unit 131 to be printed based on the before performing the print job and the inspection result of the inspection unit 111. With this, before actually performing the printing, it is possible for the user to easily check the image quality in advance by printing the part of interest and it is possible to reduce the number of steps by occurrence of printing failure and reprinting.

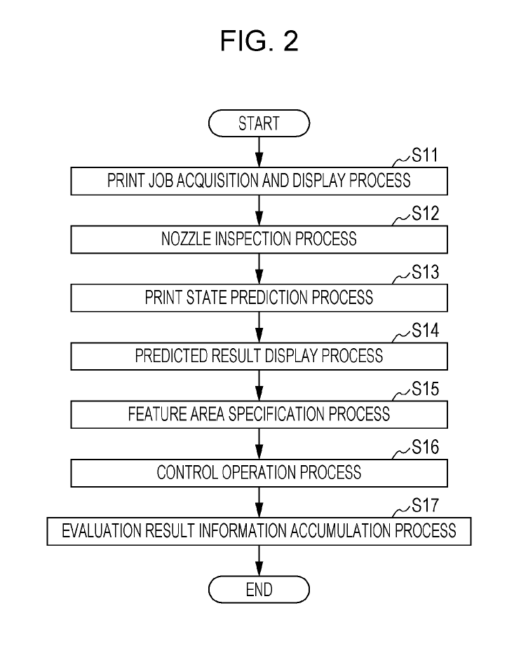

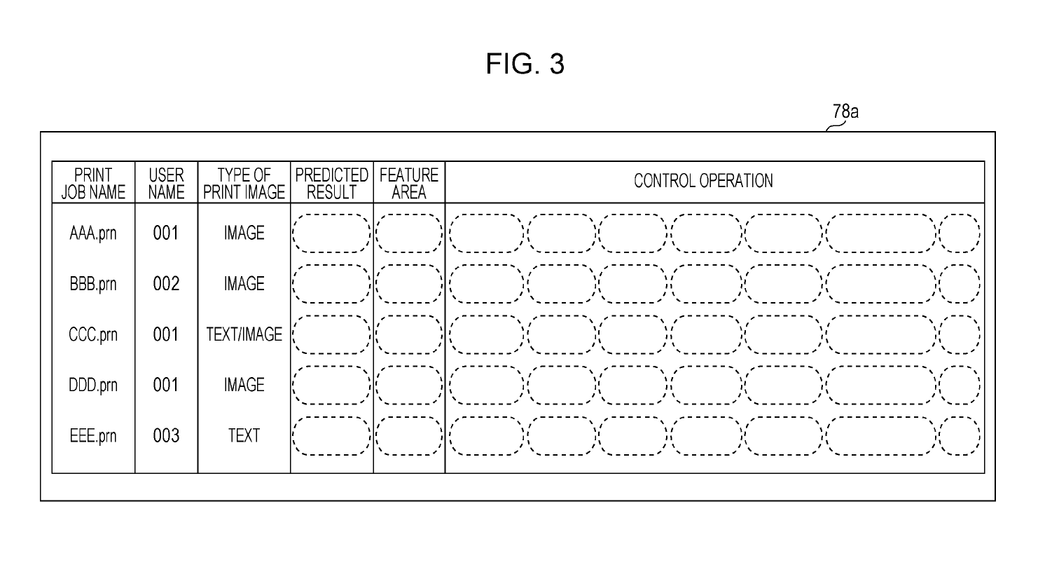

Next, a printing control method will be described. FIG. 2 is a flowchart showing the printing control method. In addition, FIG. 3 to FIG. 8 are explanatory diagrams for explaining examples of the display method in the display unit. In FIG. 2, a state in which the evaluation result information of the same print image as the print image related to the print job is stored in the evaluation result information accumulation unit 121 will be described as premise.

As described in FIG. 2, first, in step S11, a print job is acquired and displayed. Specifically, the CPU 72 acquires the print data transmitted from the plurality of the user PCs 12 through the I/F 79. The acquired print job is displayed on the display unit 78a. In an example of FIG. 3, as displayed in the field of the user name, the print data from the plurality of the user PCs 12 (user name: 001, 002, and 003) is acquired, the print job corresponding to each print data is displayed in a field of the print job name (AAA.prn to EEE.prn) (see field of print job name). In this case, timings in which the print data are acquired are displayed from the top (AAA.prn in FIG. 3) to the bottom (EEE.prn in FIG. 3) in the order of earlier.

In addition, in a field of the type of the print image, the type of the print image including the print job, for example, text data, image data, data including them, or the like is displayed.

Next, in step S12, the ejection state of the nozzle 23 is inspected. Specifically, by driving the inspection unit 111, whether or not the ink droplets can be appropriately ejected with respect to each nozzle 23 of the ejection head 24 corresponding to each color is inspected. The inspection result is temporarily stored in the RAM 74 or the like. For example, the inspection result of the ejection state of the nozzle 23 is stored as the number of nozzles that are determined to be the defective nozzle among the nozzles 23 in the ejection head 24 which ejects cyan (C) is one, the number of nozzles that are determined to be the defective nozzle among the nozzles 23 in the ejection head 24 which ejects magenta (M) is two, the number of nozzles that are determined to be the defective nozzle among the nozzles 23 in the ejection head 24 which ejects yellow (Y) is zero, the number of nozzles that are determined to be the defective nozzle among the nozzles 23 in the ejection head 24 which ejects black (K) is three, and the like.

Next, in step S13, the print state is predicted. Specifically, the CPU 72 predicts the print state relating to a target print job based on the inspection result of the ejection state of the nozzle 23 by the inspection unit 111 and the evaluation result information stored in advance in the evaluation result information accumulation unit 121 in step S12.

More specifically, for example, with respect to the print job (AAA.prn), by comparing the evaluation result information evaluated when the same print image as that of the print job (AAA.prn) in the inspection result of the ejection state of an arbitrary nozzle 23 is printed and the inspection result of the ejection state of the nozzle 23 performed in the current step S12, the print state of the current print job (AAA.prn) is predicted. That is, with respect to the print image related to the print job to be printed from now on, the current nozzle ejection state is compared with the evaluation result information when printing is performed in a certain nozzle ejection state in the past such that the quality of the print image to be printed is predicted.

As a prediction method, for example, by comparing the number of nozzles that are determined to be the defective nozzles among the nozzles 23 in the ejection head 24 of comparative evaluation result information and the number of nozzles that are determined to be the defective nozzles among the nozzles 23 in the inspection result of the ejection state of the nozzle 23 performed in this time, in a case where the number of nozzles that are determined to be the defective nozzles among the nozzles 23 in the inspection result of the ejection state of the nozzle 23 performed in this time is equal to or smaller than the number of nozzles that are determined to be the defective nozzles among the nozzles 23 in the ejection head 24 of the comparative evaluation result information, it is determined that the image quality is secured when it is determined that there is no problem in the evaluation result in the evaluation result information and it is predicted that the printing is possible (printing is OK). Meanwhile, in a case where the number of nozzles that are determined to be the defective nozzles among the nozzles 23 in the inspection result of the ejection state of the nozzle 23 performed in this time is greater than the number of nozzles that are determined to be the defective nozzles among the nozzles 23 in the ejection head 24 of the comparative evaluation result information, it is determined that securing of the image quality is difficult, and it is predicted that the printing is impossible (printing is NG).

In step S13, the print state is predicted for the plurality of print jobs acquired up to a certain point of time in the same manner as described above. For example, with respect to the print job (BBB.prn), by comparing the evaluation result information evaluated when the same print image as that of the print job (BBB.prn) in the inspection result of the ejection state of an arbitrary nozzle 23 is printed and the inspection result of the ejection state of the nozzle 23 performed in the current step S12, the print state of the current print job (BBB.prn) is predicted. Similarly, other print jobs can be predicted.

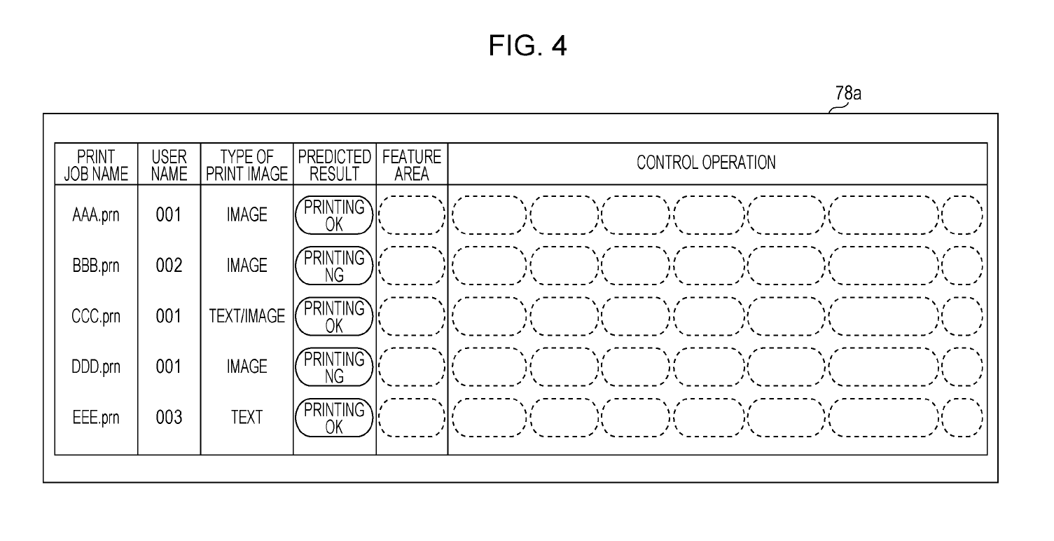

Next, in step S14, the predicted result is displayed on the display unit 78a. Specifically, as shown in FIG. 4, “printing is OK” or “printing is NG” is displayed for each print job in the field of the predicted result of the display unit 78a. In an example of FIG. 4, the print job: AAA.prn indicates “printing is OK”, the print job: BBB.prn indicates “printing is NG”, the print job: CCC.prn indicates “printing is OK”, the print job: DDD.prn indicates “printing is NG”, and the print job: EEE.prn indicates “printing is OK”.

As shown in FIG. 4, since the predicted result of each print job is displayed on the display unit 78a and the user can predict occurrence and failure of the print image of each print job by checking the display unit 78a, it is possible to enhance the productivity of the print process. That is, even in a case where the defective nozzle occurs in the inspection result of the inspection unit 111, by adding a past result in the evaluation result information accumulation unit 121, it is possible to perform, for example, the print process without performing the cleaning.

Next, in step S15, the feature area of the print image in the print job is specified. Specifically, whether or not the feature area set in advance by the specification unit 131 is included in the print image is searched. For example, whether or not there is a gray color in an area equal to or greater than the image size 100 mm×100 mm is searched. In a case where the set feature area and the print image coincide with each other, it is specified that the area is the feature area.

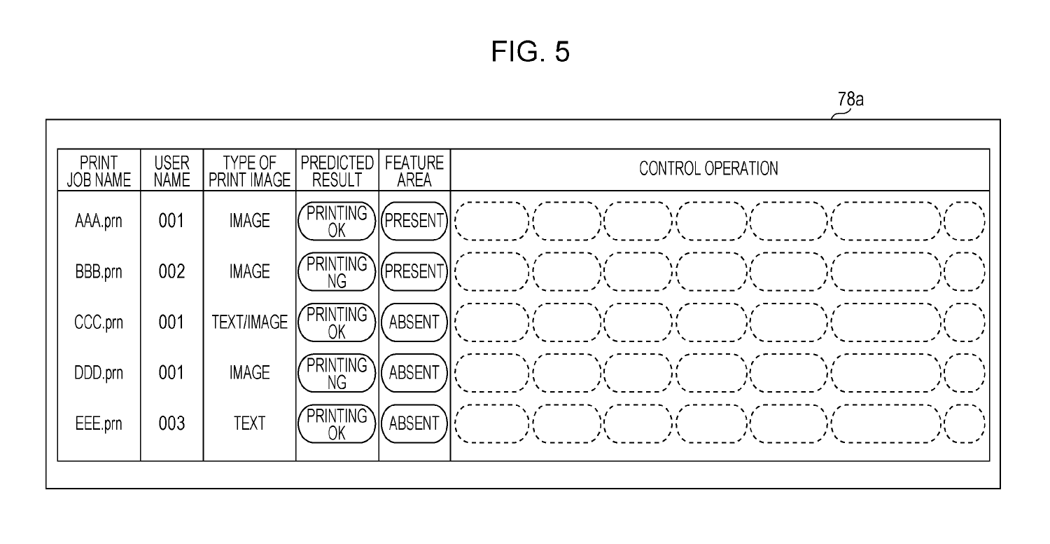

As shown in FIG. 5, in a case where there is the feature area in a field of the feature area of the display unit 78a, “present” is displayed. Meanwhile, in a case where there is no feature area, “absent” is displayed. With this, the user can recognize that the print image includes the feature area with respect to the print job, and can predict the possibility of occurrence of streak unevenness or the like.

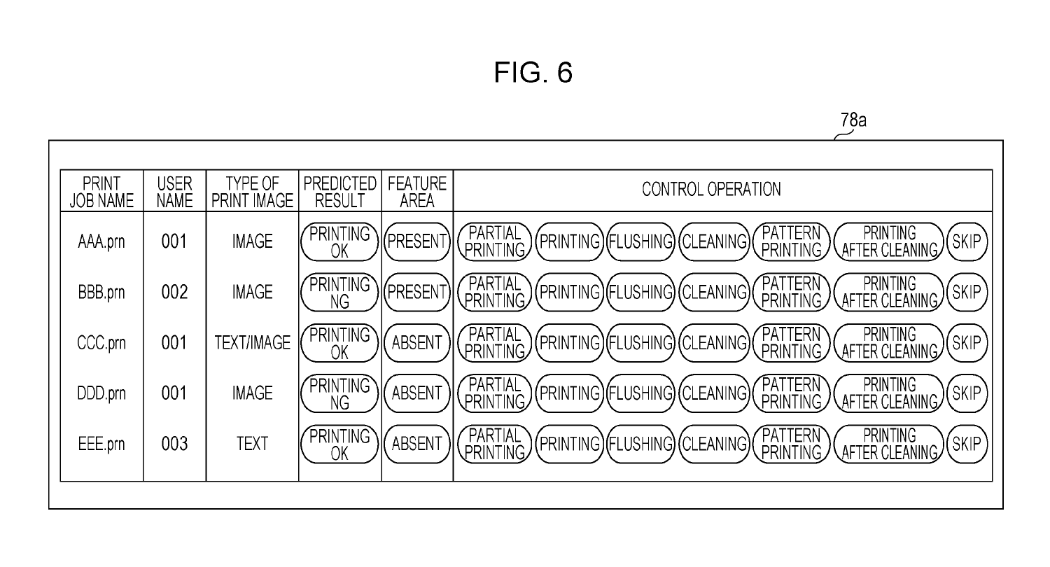

Here, at a time of completing up to step S15, the control operation is displayed on the display unit 78a. Specifically, as shown in FIG. 6, the control operation which can be handled in the printing apparatus 20 is displayed. As an example of contents of the control operation, there are “partial printing”, “printing”, “flushing”, “cleaning”, “pattern printing”, “printing after cleaning”, “skip”, and the like. A display portion of each control operation displayed on the display unit 78a can be selected and the user can perform a selected control operation by selecting one of them. The control operation may be performed by selecting the control operation by the operation unit 78b.

In an example of FIG. 6, all control operations corresponding to each print job are displayed, but the embodiment is not limited thereto. Only selectable control operation corresponding to the presence or absence result of the predicted result and the feature area may be displayed. For example, in the print job (AAA.prn), since the predicted result is the “printing is OK” and the feature area is the “present”, as the control operation to be displayed, only “partial printing” and “printing” may be used. In addition, in the print job (BBB.prn), since the predicted result is the “printing is NG”, as the control operation to be displayed, only “flushing”, “cleaning”, and “pattern printing” may be displayed.

Next, in step S16, the selected control operation is performed.

Here, the control operation of the “partial printing” in the field of the control operation is the control operation associated with the specification of the feature area of the specification unit 131, the printing mechanism 21 and causes a part of the specified feature area to be printed on the recording sheet S by driving the sheet feed mechanism 30 or the like. With this, before starting the print job, the user can check a part of an image which is the feature area. Then, after checking the printed image, it is possible to select the “printing” or the “cleaning”. Therefore, it is possible for the user to easily check the image quality in advance, it is possible to reduce the number of steps by the occurrence of printing failure and the reprinting.

In addition, the control operation of the “printing” in a field of the control operation causes to perform the print job. By driving the printing mechanism 21, the sheet feed mechanism 30, and the like, an image is formed on the recording sheet S.

In addition, the control operation of the “flushing” in the field of the control operation is a maintenance operation of the ejection head 24, faces the ejection head 24 to the flushing area 52 of the capping device 40, and ejects the ink from the nozzle 23 toward the flushing area 52, by driving the printing mechanism 21. With this, it is possible to recover the ejection state of the nozzle 23 in which foreign substances or the like attached within the nozzle 23 are eliminated. After performing the “flushing”, it is possible for the user to select the “printing”, the “cleaning”, and the like according to status of the ejection head 24. For example, after performing the “flushing”, the status of the ejection head 24 is checked again. As a result, when the number of the defective nozzles decreases before the “flushing” and the number of defective nozzles that seem to have minimal influence on image quality are reached, the “printing” is selectively displayed. When the number of the defective nozzles is equal to or greater than that before performing the “flushing”, the “cleaning” may be selectively displayed.

In addition, the “cleaning” in the field of the control operation is a cleaning operation of the ejection head 24, and causes the capping device 40 to be driven. At this time, in a state where the ejection head 24 is sealed by the capping device 40, the negative pressure occurs, and the ink within the nozzle 23 is forcibly sucked out. Then, after performing the “cleaning”, it is possible for the user to select the “printing” and the like according to the status of the ejection head 24. For example, after performing the “cleaning”, the status of the ejection head 24 is checked again. As a result, when the number of the defective nozzles decreases before the “cleaning” and the number of defective nozzles that seems to have minimal influence on the image quality is reached, the “printing” is selectively displayed. When the number of the defective nozzles is equal to or greater than that before the “cleaning”, the “printing” may be displayed not to be selected and the “cleaning” may be selectively displayed.

In addition, the “pattern printing” in the field of the control operation is an operation for printing a test pattern. By driving the printing mechanism 21, the sheet feed mechanism 30, and the like, a test pattern formed from a set of a plurality of straight lines corresponding to each nozzle 23 is printed by ejecting the ink from the nozzle 23 (for example, 100 shots). It is possible for the user to check the ejection state of the nozzle 23 by the printed test pattern. After performing the “pattern printing”, it is possible for the user to select the “printing”, the “cleaning”, and the like according to the status of the ejection head 24.

In addition, the “printing after cleaning” in the field of the control operation is an example of reservation of the control operation of the printing apparatus 20, and is an operation for performing the print job after performing the cleaning operation. That is, when the cleaning is completed, the process automatically proceeds to a printing operation. With this, it is unnecessary that the user waits for in the printing apparatus 20 until the cleaning is completed, and the convenience of the user is improved.

The control operation already reserved can be canceled. In this case, before performing the preserved control operation, the control operation already reserved is canceled. Cancel means is not specifically limited. A configuration in which the cancellation is performed by pushing a reserved display switch twice or the cancellation may be performed by selecting the control operation reserved by the operation unit 78b, may be implemented. In this manner, it is possible to cope with the ejection state of the nozzle 23 changed while the printing apparatus 20 is in operation.

Furthermore, a condition of a case where the control operation already reserved is canceled can be set. In this case, the cancel condition can be set for each the user. These settings can be set in a field of a setting menu of the operation panel 78. With this, since the cancel condition can be set for each user, it is possible to improve the convenience. The cancel condition may be set for the user, or may be set for each print image of the print job.

The “skip” in the field of the control operation is an operation for changing a processing order of a target print job. Normally, each control operation process is performed in the order of acquiring the print job, but the processing order of the print job is changed by selecting the “skip”. In the embodiment, by selecting the “skip” of the target print job, it is possible to change a target processing order of the print job to be performed after a part of other print jobs.

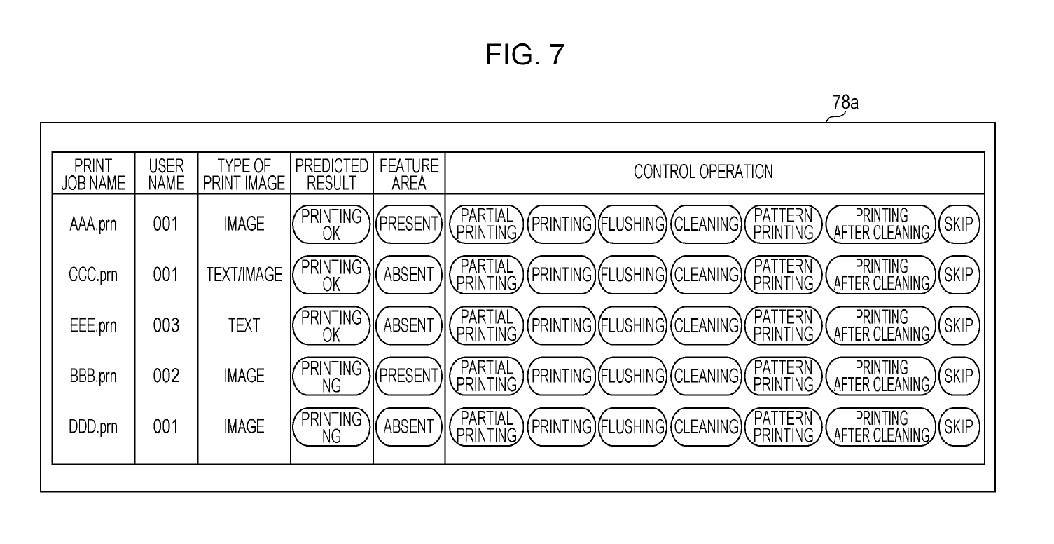

Specifically, in FIG. 6, the “skip” is selected in the field of the control operation of the print job (BBB.prn) and the selected skip is performed. With this, as shown in FIG. 7, the processing order of the print job (CCC.prn) is repeated after the print job (AAA.prn). In addition, the “skip” in the field of the control operation of the print job (DDD.prn) is selected and performed. In this case, as shown in FIG. 7, the “skip” is selected so as to be the processing order of the print job (EEE.prn) after the print job (CCC.prn).

With this, as shown in FIG. 7, the print jobs of which the predicted result of the print state is the “printing is OK” are arranged in a continuous group. Meanwhile, the print jobs of which the predicted result of the print state is the “printing is NG” are in descending order. Therefore, by switching the processing order of the print jobs according to the predicted result of the print state, it is possible to shorten a stagnation period of the printing apparatus 20, and it is possible to improve the productivity of the print process. In addition, the “skip” process may be automatically selected according to the status of the ejection head 24, and can be selected by the user according to the status of the ejection head 24.

Next, in step S17, the evaluation result information is accumulated. Specifically, the “printing” in step S16 is performed, after the printing of the print job is completed, an evaluation result input menu is displayed on the display unit 78a of the operation panel 78 (input unit), the user inputs the evaluation result. A timing at which the user inputs the evaluation result may be input by the user from a job list even when the user cancels the printing by determining a printing result as the “printing is NG” during the printing, or even after completing the printing.

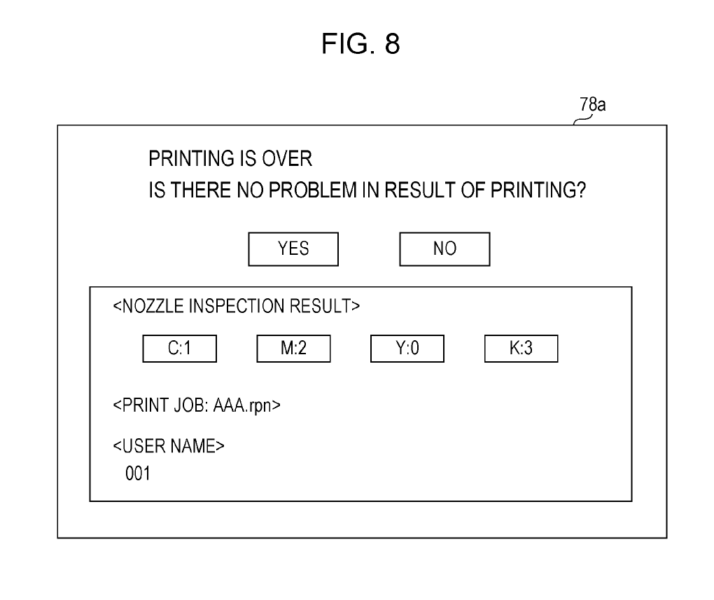

Specifically, as shown in FIG. 8, the evaluation result input menu is displayed on the display unit 78a.

The user checks the printed print image, and selects “YES” in a case where there is no problem in the printing result. Meanwhile, the user selects “NO” in a case where there is a problem in the printing result.

In addition, on the evaluation result input menu of the display unit 78a, a result acquired by associating the printed print job name, the inspection result of the ejection state of the nozzle 23 at the time of printing, and the user name is displayed.

Then, the input evaluation result is stored in the evaluation result information accumulation unit 121 as the evaluation result information. Therefore, the evaluation result information acquired by associating the inspection result of the ejection state of the nozzle 23 and the quality of the print image is accumulated on the evaluation result information accumulation unit 121 with respect to the print image of the print job. The evaluation result information is similarly accumulated in other print jobs. With this, when printing the same image of the next print job, by adding the inspection result of the ejection state of the nozzle 23 and the evaluation result information, it is possible to predict the print state and to easily perform determination whether or not the print process can be performed.

So far, according to the embodiment, it is possible to acquire the following effects.

Based on the inspection result of the ejection state of the nozzle 23 and the evaluation result information of the print image in the past, the image quality of the print job to be printed is predicted and the predicted result is displayed on the display unit 78a. Therefore, for example, even in a case where nozzle slipping-out or the like occurs in the inspection unit 111, the print process can be performed by checking the predicted result by the user, without performing the cleaning in the print job. Therefore, it is possible to improve the productivity of the print process and to improve user's convenience.

### Second Embodiment

Next, a printing control method of a second embodiment will be described. In the first embodiment, a state where the evaluation result information of the print image of the same as the print image in the print job is accumulated in the evaluation result information accumulation unit 121 is described. In the embodiment, a case where the print image of the print job is not accumulated in the evaluation result information accumulation unit 121 before performing the print job, that is, a case where the print job including the print image to be printed for the first time is performed will be described. Since a basic configuration of a printing control apparatus and the printing apparatus of the embodiment is the same as that of the first embodiment, description thereof will be omitted.

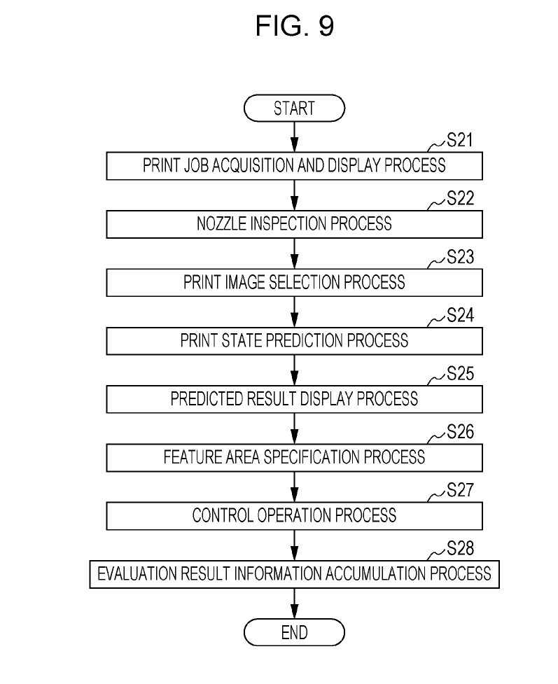

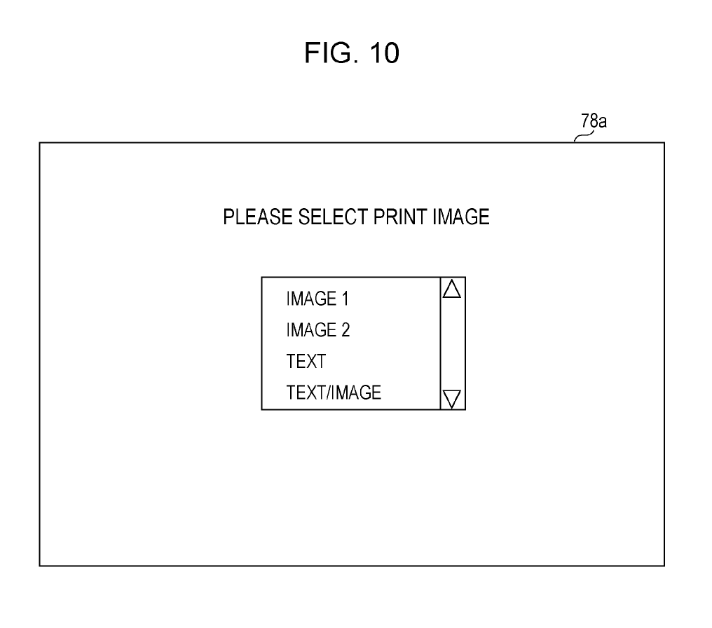

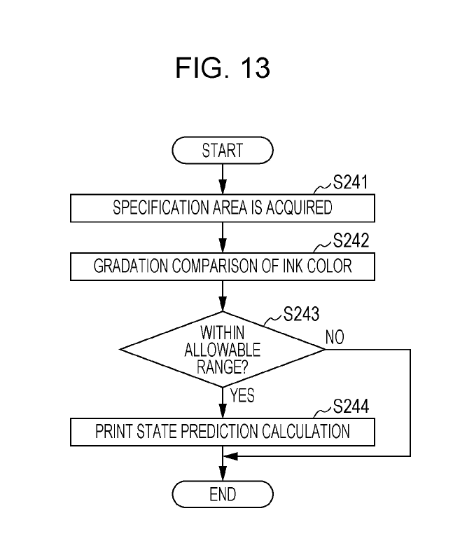

FIG. 9 is a flowchart showing the printing control method of the embodiment. FIG. 10 to FIG. 12 are explanatory diagrams for explaining examples of the display method in the display unit according to the embodiment. In addition, FIG. 13 is an explanatory diagram for explaining a part (printing predict process) of the display method in the display unit according to the embodiment in detail.

As shown in FIG. 9, first, in step S21, the print job is acquired and displayed. Specifically, the CPU 72 acquires the print data transmitted from the plurality of the user PCs 12 through the I/F 79.

In step S21, the plurality of print jobs can be acquired. Then, the acquired print job is displayed on the display unit 78a.

In the embodiment, a case where the plurality of print jobs (FFF.prn to HHH.prn) are acquired will be described. It is assumed that the print image including the plurality of print jobs acquired in step S21 is printed for the first time in the printing apparatus 20 including the printing control apparatus 70.

The type of the print image included in the print job, for example, text data, image data, or data including both are displayed in a field of the type of the print image.

Next, in step S22, the ejection state of the nozzle 23 is inspected. As a method for inspecting the ejection state of the nozzle 23 is the same as that of the first embodiment, description thereof will be omitted.

Next, in step S23, a print image selection process is performed.

In the embodiment, since the print image of the print job is printed for the first time, the evaluation result information acquired by evaluating the same print image is not accumulated in the evaluation result information accumulation unit 121.

Therefore, before performing the print job, it is impossible to predict the print state of the print image of the print job. In the embodiment, the evaluation result information of another print image similar to the print image of the print job is selected from the evaluation result information accumulation unit 121, and the print state of the print image of the print job is predicted by using another print image similar to the print image of the print job.

Specifically, first, as shown in FIG. 10, in a screen of a print image selection menu of the display unit 78a, the print image which is considered to be similar to the print image to be printed this time is selected from the print images accumulated in the evaluation result information accumulation unit 121. In an example of FIG. 10, an image 1, an image 2, a text, and one of a text and an image are selected.

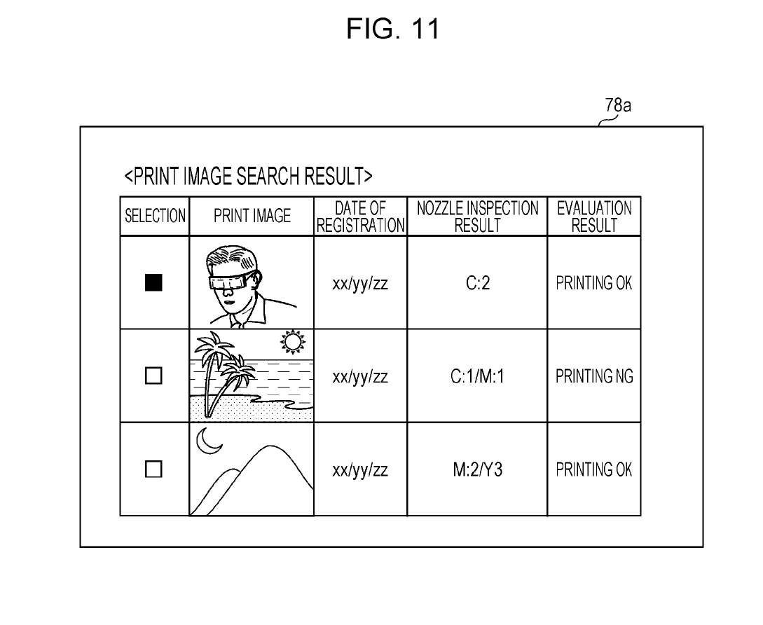

When the print image which is considered to be similar is selected, as shown in FIG. 11, from the print images accumulated in the evaluation result information accumulation unit 121, the searched print images are listed and displayed on the display unit 78a. In an example of FIG. 11, a state where three print images are searched is displayed.

Next, from the searched and displayed print image, in order to predict the print state of the print image of the current print job in this time, the print image to be a comparison target is selected. For example, the selection method is selected. In the selection method, the print image is selected from the viewpoint of color, color arrangement, or the like. A selection process is performed by performing checking on a selection mark. At this time, in a case where there is no target image, it may be the same as the configuration of the first embodiment as a case where it is not stored in the evaluation result information accumulation unit 121.

Next, in step S24, the print state prediction calculation is performed. The details of step S24 will be described by using FIG. 13.

First, it is determined whether the prediction is possible by comparing the print image of the current print job and the selected print image in step S23. Specifically, as shown in FIG. 13, a specification area is acquired in step S241 (step S241). In this case, the feature area of each of the current print image and the selected print image is specified by the specification unit 131. For example, the feature area (image size 100 mm×100 mm) in the current print image and the feature area (100 mm×100 mm) in the selected print image are specified (acquired).

Next, in step S242, gradation between ink colors are compared. Specifically, each gradation between ink colors in the feature area (image size 100 mm×100 mm) of the current print image and the gradation between ink colors in the feature area (100 mm×100 mm) of the selected print image are compared with each other and difference is calculated.

Next, in step S243, it is determined whether or not a comparison (difference) value is within the allowable range. For example, if the difference of the gradation between ink colors is less than 10%, it is determined that prediction is possible. That is, it is determined that the evaluation result information of the selected print image may be used with respect to the prediction of the print state of the current print image. The process proceeds to step S244.

If the difference of the gradation between all ink colors is less than 10%, it is determined that the prediction is possible. If the difference in the gradation of any of the ink colors among all ink colors is less than 10%, it may be determined that the prediction is possible. A determination criteria can be appropriately determined.

Meanwhile, for example, the difference of the gradation of each ink color is equal to or greater than 10%, it is determined that the prediction is impossible. That is, it is determined that the evaluation result information of the selected print image cannot be used with respect to prediction of the print state of the current print image. In this case, the printing predict process is completed.

The number of the feature areas to be compared is not limited to one, but a plurality of feature areas may be set. In addition, the image size of the feature area to be compared is not limited to one, and a plurality of image sizes may be set the feature area. In this case, the image size may be set such that priority of the determination criteria becomes one higher than that of a smaller image size.

Next, in step S244, print prediction is calculated. Specifically, based on the inspection result of the ejection state of the nozzle 23 by the inspection unit 111 in step S22 and the evaluation result information of the selected print image in step S243, the print state relating to the current print job is predicted. More specifically, for example, with respect to the print job (FFF.prn), the print state of the current print job (FFF.prn) is predicted by comparing the evaluation result information of the selected print image and the inspection result of the ejection state of the nozzle 23 performed in the step S22. That is, with respect to the print image of the print job to be printed, by comparing a current nozzle ejection state and the evaluation result information at the time of printing in the nozzle ejection state which is the print image similar to the current print image performed in the past, the print state of the print image to be printed is predicted.

As the prediction method, for example, by comparing the number of the defective nozzles which is the number of nozzles determined as the defective nozzle among the nozzles 23 in the ejection head 24 of the comparative evaluation result information and the number of the defective nozzles in the inspection result of the ejection state of the nozzle 23 performed this time, in a case where the number of the defective nozzles in the inspection result of the ejection state of the nozzle 23 performed in this time is smaller than the number of the defective nozzles in the ejection head 24 of the comparative evaluation result information, it is determined that the image quality is secured such that it is predicted that the printing is possible (printing is OK).

In step S243, with respect to one determined that the prediction is possible based on the difference of the gradation of any of ink colors less than 10% among all ink colors, for example, it is predicted that printing is possible once (printing is OK?).

Meanwhile, in a case where the number of the defective nozzles in the inspection result of the ejection state of the nozzle 23 performed this time is greater than the number of the defective nozzles in the ejection head 24 of the comparative evaluation result information, it is determined that securing of the image quality is difficult and it is predicted that the printing is impossible (printing is NG).

In step S24, the print state is predicted for the plurality of print jobs acquired up to a certain point of time as described above.

Next, in step S25, the predicted result is displayed on the display unit 78a.

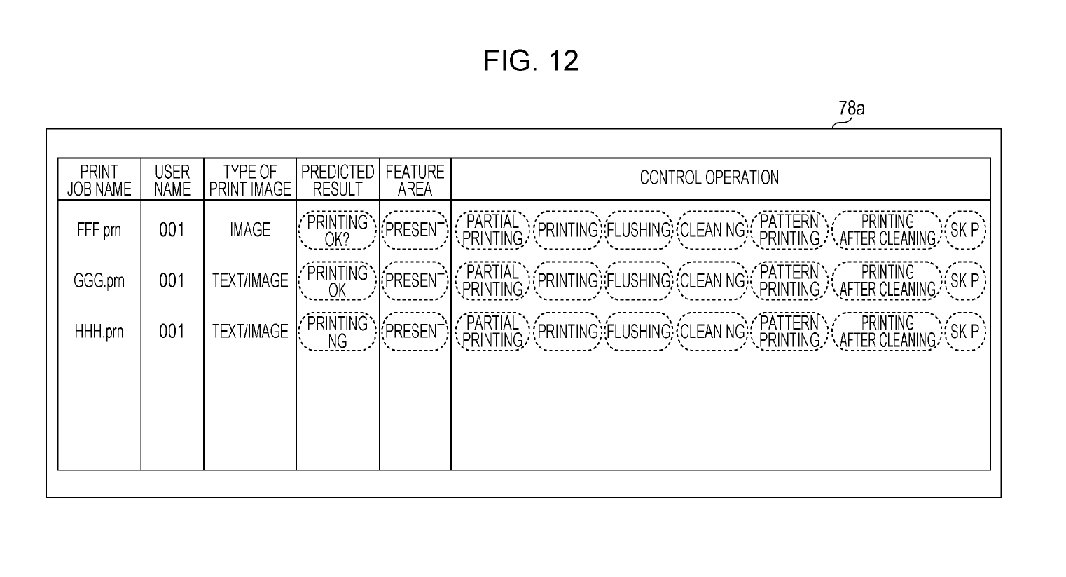

Specifically, as shown in FIG. 12, in a field of the predicted result of the display unit 78a, the “printing is OK”, the “printing is OK?”, and the “printing is NG” are displayed for each print job. The “printing is OK?” is displayed in a case where determination whether or not the image quality of the printing result in step S24 is secured is performed and it is predicted that printing is possible.

As shown in FIG. 12, since the predicted result of each print job is displayed on the display unit 78a, even the print image to be printed for the first time before performing the print job by checking the display unit 78a by the user, it is possible to improve the productivity of the printing apparatus based on good or poor of the print image which can be predicted.

Next, in step S26, the feature area of the print image in the print job is specified. Next, in step S27, the selected control operation is performed. Since step S26 and step S27 are the same as those of the first embodiment, description thereof will be omitted.

Next, in step S28, the evaluation result information is accumulated. Specifically, in step S27, the “printing” is performed, the evaluation result input menu is displayed on the display unit 78a of the operation panel 78 (input unit), and the user inputs the evaluation result after the printing of the print job is completed (see FIG. 8). With this, in a case where the evaluation result information of the current print image to be printed for the first time is associated with the inspection result of the ejection state of the nozzle 23, the evaluation result information is stored in the evaluation result information accumulation unit 121.

As described above, according to the embodiment, it is possible to acquire the following effects.

Even in a case where the print process is performed on the print image included in the print job for the first time, by using the evaluation result information of similar print image, it is possible to predict the print state. With this, it is possible to reduce burden on the user and improve the productivity.

The invention is not limited to the above-described embodiments, and various modifications, improvements, and the like can be added to the above-described embodiments. Modification Examples will be described below.

### Modification Example 1

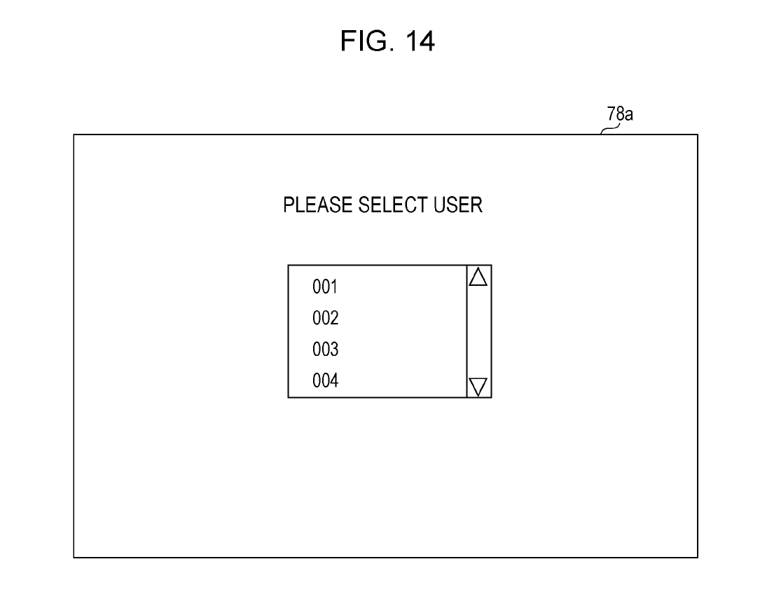

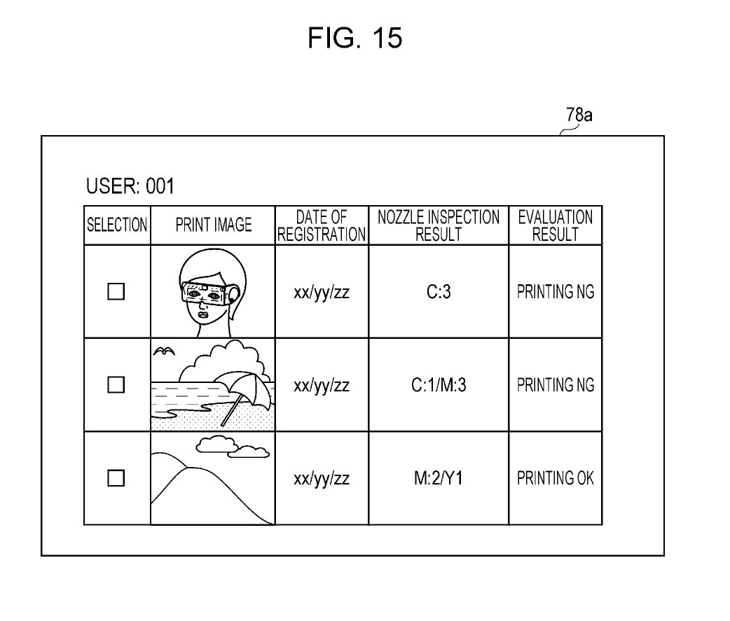

In the print image selection process (step S23) of the printing control method of the second embodiment, the print image which is considered to be similar to the current print image to be printed is selected from all print images stored in the evaluation result information accumulation unit 121 (see FIG. 10), but is not limited thereto. FIG. 14 and FIG. 15 are explanatory diagrams for explaining an example of the display method in the display unit according to the modification example. Information relating to the user is included in the evaluation result information stored in the evaluation result information accumulation unit 121 (see FIG. 8). Accordingly, the print image stored for each user may be classified, and the print image handled by the user scheduled to be printed may be selected.

Specifically, as shown in FIG. 14, in a screen of a user selection menu of the display unit 78a, a desired user is selected from the users (in example of FIGS. 14, 001 to 004) registered in the evaluation result information accumulation unit 121. As shown in FIG. 15, when a desired user is selected, from the print images accumulated in the evaluation result information accumulation unit 121, the print image handled by a corresponding user in the past is listed and displayed on the display unit 78a. In an example of FIG. 15, a state in which three print images are searched is displayed. It is possible to perform a selection process by checking the selection mark from the print images listed and displayed. In this manner, it is possible to perform the prediction of the print state based on the evaluation for each user. At this time, by acquiring histograms of the print image and an image scheduled to be printed and comparing similarity therebetween, the selection process may be automatically performed.

### Modification Example 2

In the embodiment, while performing a certain print job, based on the inspection result of the inspection unit 111 and the evaluation result information according to other print jobs, the print state relating to other print jobs may be predicted, and the predicted result may be displayed on the display unit 78a. In this manner, while performing a certain print job, since determination of the printing performance of the next print job is performed, it is possible to improve the user's convenience. That is, since the ejection state of the nozzle 23 is changed at any time according to the performance of other print jobs and the predicted result is updated, it is possible to perform an appropriate process.

### Modification Example 3

In the embodiment, the ink cartridge 26 is configured as a so-called on-carriage mounted on the reciprocating carriage 22, but a so-called off-carriage which is attached to the housing 39 and supplies ink or the like to the ejection head 24 may be adopted. In addition, the printing mechanism 21 includes the carriage 22 that moves in a carriage moving direction. However, a so-called line ink jet head in which nozzle rows of each color are provided in a width direction of the recording sheet S may be provided.

This application claims priority under 35 U.S.C. § 119 to Japanese Patent Application No. 2017-052344, filed Mar. 17, 2017. The entire disclosure of Japanese Patent Application No. 2017-052344 is hereby incorporated herein by reference.

What is claimed is:

1. A printing control apparatus comprising:
an inspection result acquisition unit that acquires an inspection result of an ejection state in each of a plurality of nozzles in an ejection head having the nozzles; and
an evaluation result acquisition unit that acquires evaluation result information from an evaluation result acquired by evaluating a print image printed in an accumulated ejection state of the nozzle,
wherein before performing a print job, based on the inspection result and the evaluation result information, a print state relating to the print job is predicted and the predicted result is displayed.

2. The printing control apparatus according to claim 1,
wherein a plurality of the print jobs are displayed, and
an order of performing the print jobs can be changed.

3. The printing control apparatus according to claim 1, further comprising:
a specification unit that specifies a feature area of the print image in the print job,
wherein the before performing the print job, a part of the specified feature area is printed.

4. The printing control apparatus according to claim 1,
wherein after the print job is completed, the evaluation result information that is input is accumulated in an evaluation result information accumulation unit.

5. The printing control apparatus according to claim 1,
wherein information relating to a user is included in the evaluation result information.

6. The printing control apparatus according to claim 1,
wherein the predicted result of each print job is displayed, a control operation corresponding to each of the predicted results is displayed, and the control operation is reserved.

7. The printing control apparatus according to claim 6,
wherein the control operation already reserved can be canceled.

8. The printing control apparatus according to claim 7,
wherein a condition of canceling the control operation already reserved can be set.

9. The printing control apparatus according to claim 1,
wherein while performing the print job, based on the inspection result and the evaluation result information of other print jobs, the print state relating to other print jobs is predicted and the predicted result is displayed.

10. A printing control method of a printing control apparatus that inspects an ejection state in each of a plurality of nozzles in an ejection head having the nozzles and acquires evaluation result information from an evaluation result acquired by evaluating a print image printed in an accumulated ejection state of the nozzle, the method comprising:
before performing a print job,
predicting a print state relating to the print job based on the inspection result and the evaluation result information; and
displaying the predicted result.

11. A printing apparatus comprising:
the printing control apparatus according to claim 1.

12. A printing apparatus comprising:
the printing control apparatus according to claim 2.

13. A printing apparatus comprising:
the printing control apparatus according to claim 3.

14. A printing apparatus comprising:
the printing control apparatus according to claim 4.

15. A printing apparatus comprising:
the printing control apparatus according to claim 5.

16. A printing apparatus comprising:
the printing control apparatus according to claim 6.

17. A printing apparatus comprising:
the printing control apparatus according to claim 7.

18. A printing apparatus comprising:
the printing control apparatus according to claim 8.

19. A printing apparatus comprising:
the printing control apparatus according to claim 9.
